(19) United States
(12) Patent Application Publication
(10) Pub. No.: US 2025/0207792 A1
(43) Pub. Date: Jun. 26, 2025

(54) AIR CONDITIONING AND STERILIZATION SYSTEM

(71) Applicants: Junichi SUZUKI, Funabashi-city (JP); Taro SAITOU, Tokyo (JP); MATSUEI CONSTRUCTION, INC., Sakai-city (JP)

(72) Inventor: Junichi SUZUKI, Funabashi-city (JP)

(73) Assignees: Junichi SUZUKI, Funabashi-city (JP); Taro SAITOU, Tokyo (JP); MATSUEI CONSTRUCTION, INC., Sakai-city (JP)

(21) Appl. No.: 18/756,520

(22) Filed: Jun. 27, 2024

(30) Foreign Application Priority Data
Dec. 21, 2023 (JP) 2023-215436

(51) Int. Cl. F24F 3/16; F24F 3/04; F24F 8/22; F24F 110/10; F24F 110/20; F24F 110/70; F24F 110/72

(52) U.S. Cl. CPC F24F 3/16; F24F 3/04; F24F 8/22; F24F 2110/10; F24F 2110/20; F24F 2110/70; F24F 2110/72

(57) ABSTRACT

In an air conditioning and sterilization system, air supply ports and exhaust ports are provided to rooms of a building, respectively, air supply pipes and exhaust pipes are connected to the air supply ports and the exhaust ports, an air conditioning room is between the air supply pipes and the exhaust pipes to adjust temperature and humidity of an air, and the air is circulated in each of the rooms. The air conditioning room includes ventilation means that introduces external air into the air conditioning room, sterilization means that irradiates the air inside the air conditioning room with an ultraviolet ray having a dominant wavelength of 254 nm to sterilize the air, and a blower that supplies the sterilized air to each of the rooms and discharges the air from the exhaust ports by making each room have a positive pressure and the air conditioning room have a negative pressure.

### BACKGROUND

### 1. Technical Field

The present invention relates to an air conditioning and sterilization system for performing ventilation and sterilization of an air circulating in a room of a building.

### 2. Related Art

Conventionally, Building Standards Act requires buildings to be equipped with ventilation equipment. The ventilation equipment is a 24-hour ventilation system, and circulates air in a room having high air tightness and sealability to change the air in the room, that is, perform ventilation. The ventilation is performed to meet standard values or less of formaldehyde (HCHO), carbon monoxide, carbon dioxide, floating dust, and the like under Building Standards Law and ordinances. For example, bathroom ventilation is to be performed 15 to 20 times (per hour), kitchen ventilation is to be performed 40 to 60 times (per hour), and toilet ventilation is to be performed 10 to 15 times (per hour) as a guide. But there is a large difference in temperature and humidity between summer and winter, and it is difficult to maintain an environment meeting the standard values.

Meanwhile, air conditioning throughout the building that performs air conditioning, that is, cooling and heating, of the whole building is used. The air conditioning throughout the building is not the air conditioning for each room of the building with an air conditioner, but the air conditioning inside the whole building including a corridor and the like to reduce the temperature difference between the rooms.

Further, to make the room environment safe, there is a technique of an air conditioning system with means to sterilize bacteria, viruses, and the like in the room.

A device disclosed in JP-A-H11-14130 includes sterilization means in a duct that connects an air conditioner to a room.

A system disclosed in JP-A-2022-1219 includes an air circulation path in a space provided with an air conditioner and an air exhausting device, and an air in an exhaust passage is sterilized with a UV processing device to flow the ultraviolet-irradiated air form the air conditioner to the space.

However, in the technique disclosed in JP-A-H11-14130, while the sterilization process of the air supplied to each room can be performed, the sterilization process of bacteria, viruses, and the like brought into the room cannot be performed.

Further, in the system disclosed in JP-A-2022-1219, while the possibility of additional entering of bacteria and viruses from external air is reduced by not performing the ventilation process, the external air cannot be sterilized when the ventilation is to be performed under the low, and the room is possibly contaminated.

A problem to be solved by the present invention is, in consideration of the problems of the related arts described above, to provide an air conditioning and sterilization system capable of efficiently performing ventilation and sterilization of a room of a building.

### SUMMARY

The present invention provides, as first means to solve the above-described problems, an air conditioning and sterilization system in which an air supply port and an exhaust port are provided to each of rooms of a building, an air supply pipe and an exhaust pipe are connected to the air supply port and the exhaust port, an air conditioning room is disposed between the air supply pipe and the exhaust pipe to adjust a temperature and a humidity of an air, and the air is circulated in each of the rooms. The air conditioning room includes ventilation means, sterilization means, and a blower. The ventilation means introduces an external air into the air conditioning room. The sterilization means irradiates an air inside the air conditioning room with an ultraviolet ray having a wavelength of 254 nm as a dominant wavelength to sterilize the air. The blower supplies the sterilized air to each of the rooms and discharges the air from the exhaust port by making each of the rooms have a positive pressure and the air conditioning room have a negative pressure.

According to the above-described first means, since the air conditioning room can collectively manage the ventilation and the air sterilization process, the need for installing an air conditioner and a device for sterilization in each room is eliminated. Additionally, the configuration in which the collective management is performed in the air conditioning room facilitates maintenance, and allows significant reduction in power consumption and initial equipment installation cost. Further, since the inside of the air conditioning room is adjusted to the negative pressure, the circulating air can be sterilized without leakage of the air to outside.

The present invention provides, as second means to solve the above-described problems, an air conditioning and sterilization system, which is in the first means, that includes a gas sensor and a control unit. The gas sensor detects a gas concentration inside the room disposed in each of the rooms. The control unit is electrically connected to the gas sensor and the ventilation means. The control unit performs a control of introducing an external air from the ventilation means when a detected value of the gas sensor exceeds a set value.

According to the above-described second means, while a required ventilation amount can be obtained with a pollutant emission [m³/h]/(pollutant concentration-external air pollutant concentration), since gas concentrations of carbon monoxide, carbon dioxide, and the like are detected for each room, and the external air is introduced to perform ventilation when the gas concentrations exceed the set values, it is not necessary to consider the number of times of the ventilation per hour like the conventional one, and the ventilation condition can be easily satisfied.

The present invention provides, as third means to solve the above-described problems, an air conditioning and sterilization system, which is in the second means, in which the ventilation means includes ventilation sterilization means that irradiates an external air introduced by opening an opening/closing damper with an ultraviolet ray to sterilize the air.

According to the above-described third means, since infectious viruses and airborne bacteria mixed in the introduced external air can be sterilized in the air conditioning room, it is not necessary to concern about contamination of each room, and safety is provided.

The present invention provides, as fourth means to solve the above-described problems, an air conditioning and sterilization system, which is in the first means, in which the air conditioning room includes ultraviolet irradiation means that irradiates a floor surface with ultraviolet rays having wavelengths of 254 nm and 184 nm as dominant wavelengths to generate an oxygen radical.

According to the above-described fourth means, an oxygen radical is generated at a floor surface of the air conditioning room. Then, the oxygen radical is reacted with oxygen in the air to generate ozone, thus inactivating black molds to allow avoiding occurrence of molds.

The present invention provides, as fifth means to solve the above-described problems, an air conditioning and sterilization system, which is in the first means, in which the sterilization means is disposed at an air supply port side opening and an exhaust port side opening in the air conditioning room.

According to the above-described fifth means, the sterilization means can be easily mounted even at a narrow installation space in the air conditioning room. Since the sterilization means are collectively disposed in the air conditioning room, satisfactory maintainability is provided.

According to the present invention, since the air conditioning room can collectively manage the ventilation and the air sterilization process, the need for installing an air conditioner and a device for sterilization in each room is eliminated. Additionally, the configuration in which the collective management is performed in the air conditioning room facilitates maintenance, and allows significant reduction in power consumption and initial equipment installation cost.

### BRIEF DESCRIPTION OF DRAWINGS

FIG. 1 is a schematic diagram of an air conditioning and sterilization system of the present invention; and

FIG. 2 is a plan view of the air conditioning and sterilization system of the present invention.

### DETAILED DESCRIPTION

The following describes an embodiment of the air conditioning and sterilization system according to the present invention in detail with reference to the drawings.

### Air Conditioning and Sterilization System 10

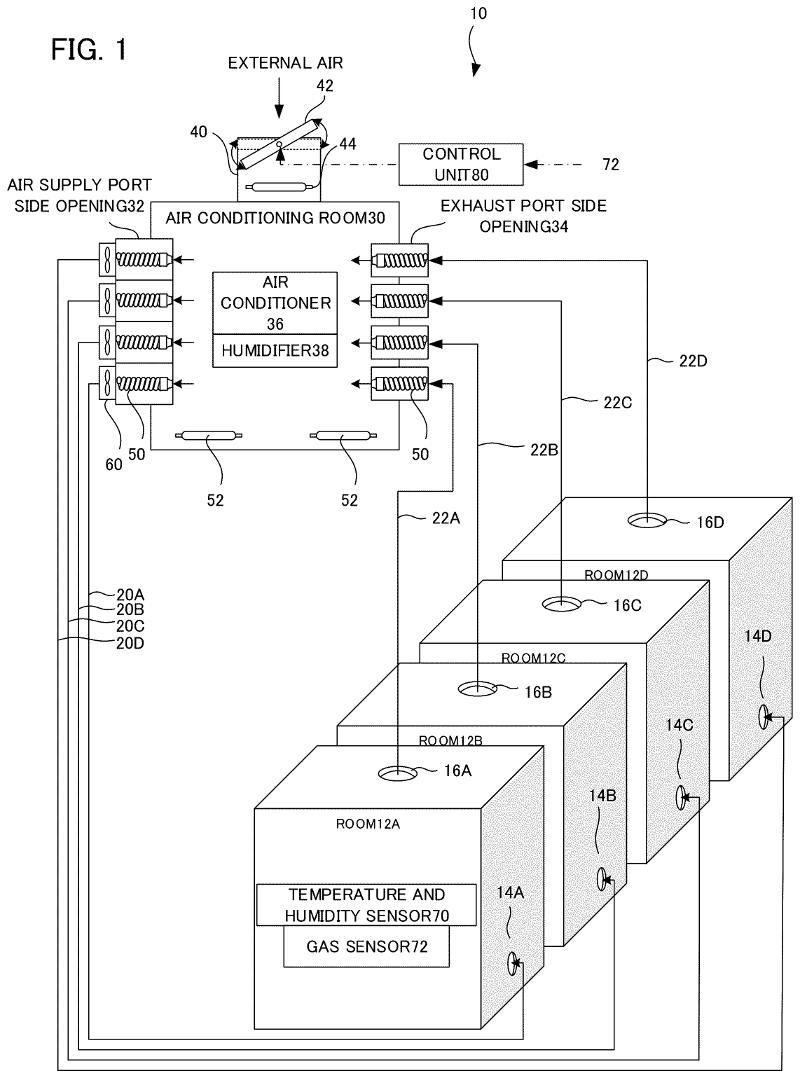

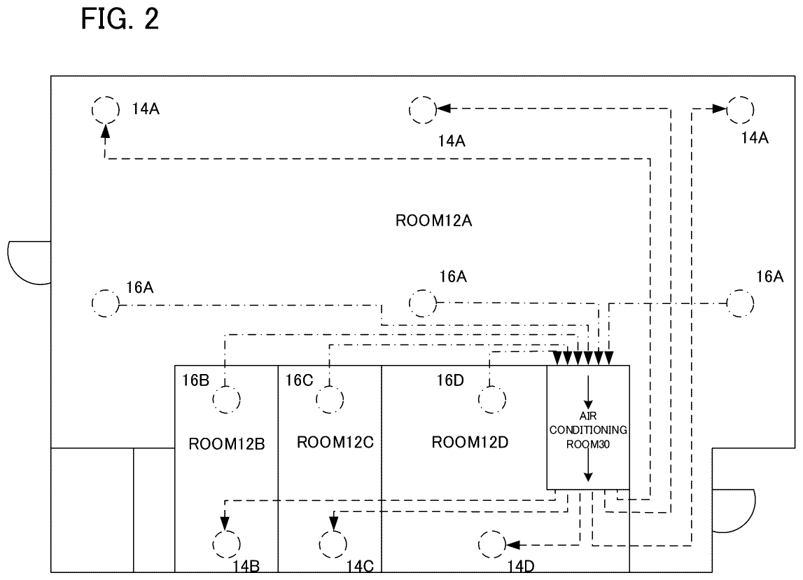

FIG. 1 is a schematic diagram of an air conditioning and sterilization system of the present invention. FIG. 2 is a plan view of the air conditioning and sterilization system of the present invention.

An air conditioning and sterilization system 10 of the present invention is an air conditioning and sterilization system in which air supply ports 14A, 14B, 14C, 14D and exhaust ports 16A, 16B, 16C, 16D are provided to rooms 12A, 12B, 12C, 12D of a building, respectively, air supply pipes 20 and exhaust pipes 22 are connected to the air supply ports 14A, 14B, 14C, 14D and the exhaust ports 16A, 16B, 16C, 16D, an air conditioning room 30 is disposed between the air supply pipes 20 and the exhaust pipes 22 to adjust a temperature and a humidity of an air, and the air is circulated in each of the rooms 12A, 12B, 12C, 12D. The air conditioning room 30 includes ventilation means 40 that introduces an external air into the air conditioning room, sterilization means 50 that irradiates the air inside the air conditioning room with an ultraviolet ray having a wavelength of 254 nm as a dominant wavelength to sterilize the air, and a blower 60 that supplies the sterilized air to each of the rooms 12A, 12B, 12C, 12D and discharges the air from the exhaust ports 16A, 16B, 16C, 16D by making each room have a positive pressure and the air conditioning room 30 have a negative pressure.

While each of the rooms 12A, 12B, 12C, 12D in the building is provided with an opening/closing door, a window, and the like, the rooms are partitioned by walls, and each form a space having a high air tightness in a state where the door and the window are closed. The rooms 12A, 12B, 12C, 12D are provided with the air supply ports 14A, 14B, 14C, 14D at lower wall surfaces and the exhaust ports 16A, 16B, 16C, 16D at ceilings, respectively. The air supply ports 14A, 14B, 14C, 14D have diameters smaller than those of the exhaust ports 16A, 16B, 16C, 16D, thereby increasing a blast pressure to increase a flow rate. While the number of the rooms is four in the description of this embodiment, the number of the rooms is not limited to this, and can be changed as necessary. The numbers of the air supply ports and the exhaust ports provided to the room can be changed as necessary depending on the size of the room.

Between the air supply ports 14A, 14B, 14C, 14D of the rooms 12A, 12B, 12C, 12D and air supply port side openings 32 of the air conditioning room 30, air supply pipes 20A, 20B, 20C, 20D are disposed. The air supply pipes 20A, 20B, 20C, 20D are ducts to perform ventilation and supply a sterilized air to the rooms 12A, 12B, 12C, 12D, respectively.

Between the exhaust ports 16A, 16B, 16C, 16D of the rooms 12A, 12B, 12C, 12D and exhaust port side openings 34 of the air conditioning room 30, exhaust pipes 22A, 22B, 22C, 22D are disposed. The exhaust pipes 22A, 22B, 22C, 22D are ducts to discharge the room air of the rooms 12A, 12B, 12C, 12D, respectively. The air supply pipes 20A, 20B, 20C, 20D and the exhaust pipes 22A, 22B, 22C, 22D of this embodiment are independent for each room, and individually connected to the air conditioning room described later without being mutually integrated. This is to avoid reduction in pressure loss of the air supply pipes and the exhaust pipes. Additionally, this is to avoid rapid pressure decay due to clogged pipes.

The air conditioning room 30 is a small room to perform ventilation and sterilization of air, and located at the center of the building. The air conditioning room 30 includes the ventilation means 40 at the ceiling to introduce an external air, and is provided with the air supply port side openings 32 and the exhaust port side openings 34 for the air circulating in each of the rooms 12A, 12B, 12C, 12D at opposed wall surfaces. The air supply port side openings 32 and the exhaust port side openings 34 are independently formed for the respective rooms 12A, 12B, 12C, 12D, and the same numbers of the air supply port side openings 32 and the exhaust port side openings 34 as the number of the rooms are provided side by side at the wall surfaces. The air conditioning room 30 includes an air conditioner 36 that controls a temperature of an internally circulating air to a set temperature, and a humidifier 38 that controls a humidity of the air to a set humidity. The air conditioner 36 may have an air cleaning function to remove dirt and dust in the air.

The sterilization means 50 in the air conditioning room 30 is provided to the air supply port side openings 32 and the exhaust port side openings 34. The sterilization means 50 is a spiral ultraviolet lamp configured to emit an ultraviolet ray having a wavelength of 254 nm as a dominant wavelength. The spiral ultraviolet lamp is a lamp that emits an ultraviolet ray having both or any one of the wavelengths of 254 nm and 185 nm as the dominant wavelength, and in this embodiment, the spiral ultraviolet lamps are disposed at the air supply port side openings 32 and the exhaust port side openings 34, or inside the ducts connected to the air supply port side openings 32 and the exhaust port side openings 34. The spiral ultraviolet lamp has a quartz tube formed in a spiral shape to make a tube length short, thus allowing mounting even at a narrow installation space. The sterilization means 50 can perform sterilization by destruction of bacterial cells and breaking RNA base chains of viruses with irradiation of the ultraviolet ray having the wavelength of 254 nm and a dose of 25 to 40 mJ/cm² for a dozen seconds, and can achieve, for example, inactivation of 99.999% to bacteria viruses. The sterilization means 50 generates a trace amount of ozone of 1.5 ppm or less with the ultraviolet ray having the wavelength of 185 nm. The generated ozone has effects of sterilizing and deodorizing the air.

The ventilation means 40 is a tubular ventilation duct disposed at the ceiling of the air conditioning room 30, and includes an opening/closing damper 42 that introduces external air at a distal end opening. For the opening/closing damper 42, setting of closing or a degree of opening can be changed as necessary by a control signal of a control unit 80 described later. The ventilation means 40 internally includes ventilation sterilization means 44. For the ventilation sterilization means 44, an amalgam ultraviolet lamp that can emit an ultraviolet ray having a wavelength of 254 nm as a dominant wavelength is employed. The amalgam ultraviolet lamp is a low pressure lamp in which an inert gas and an amalgam alloy are sealed inside a cylindrical quartz tube. The quartz tube is provided with a pair of electrodes at both ends in an axial direction, and includes a mixed gas of the amalgam alloy and the inert gas internally sealed with a low pressure.

The amalgam alloy is an alloy of mercury and a metal, and in this embodiment, an alloy of indium and mercury is used as an example. The amalgam alloy is welded at two positions of an inner wall of the quartz tube by a predetermined length from end portions toward the center. For the metal combined with mercury constituting the amalgam alloy, various kinds of metals can be used in addition to indium insofar as an ultraviolet ray having a wavelength of 254 nm can be emitted.

The inert gas is one in which a plurality of inert gases are mixed, and in this embodiment, a mixed gas of argon and neon is used as an example. Setting of a mixing ratio of argon gas and neon gas can be changed to various proportions.

In the amalgam ultraviolet lamp configured as described above, when a voltage is applied between the pair of electrodes, the inert gas is electrically discharged to be heated, thereby melting the amalgam alloy, the amalgam alloy is excited by discharge electrons, similarly to a low pressure mercury lamp, an ultraviolet ray having a wavelength of 254 nm as a dominant wavelength is emitted, and an ultraviolet ray having a wavelength of 184 nm is slightly emitted. Compared with the low pressure mercury lamp, the amalgam lamp is not affected even when heated by long time irradiation, for example, becoming unstable due to the decreased emission intensity of the ultraviolet ray, and the amalgam lamp can stably emit the ultraviolet ray. Furthermore, since a tube surface temperature is 150 degrees during the ultraviolet irradiation, the low temperature can be maintained compared with the low pressure mercury lamp, and the need for using heat dissipation means is eliminated.

The air conditioning room 30 includes ultraviolet irradiation means 52 that irradiates a floor surface with ultraviolet rays having wavelengths of 254 nm and 184 nm as dominant wavelengths to perform sterilization and generate ozone. For the ultraviolet irradiation means 52, an amalgam ultraviolet lamp is employed similarly to the ventilation sterilization means 44. The amalgam ultraviolet lamp emits the ultraviolet ray having the wavelength of 254 nm as the dominant wavelength, and slightly emits the ultraviolet ray having the wavelength of 184 nm. The ultraviolet ray of 184 nm generates an oxygen radical. The oxygen radical reacts with oxygen in the air to generate ozone, and by irradiating the floor surface of the air conditioning room, black molds are inactivated, thus allowing avoiding occurrence of molds.

The ultraviolet lamp disposed in the air conditioning room 30 is always on while each of the rooms is air-conditioned, and always sterilizes the circulating air. The ultraviolet lamp of this embodiment is small in heat generation, and does not become high temperature even when the ultraviolet lamp is always on. Since the sterilization means emits the ultraviolet rays with the output of 30000 pW/sec·cm² for each sterilization means, inactivation of 99% or more of bacteria and viruses in the circulating air can be achieved, thus allowing the sterilization.

The air conditioning room 30 includes the blowers 60 at the air supply port side openings 32. The blowers 60 are fans that send the air sterilized in the air conditioning room from the air supply port side openings 32 to the rooms 12A, 12B, 12C, 12D via the air supply pipes 20A, 20B, 20C, 20D. The blower 60 is set to an air blow output with which the operation of the blower 60 makes inside the air conditioning room negative pressure and inside each of the rooms 12A, 12B, 12C, 12D positive pressure. Therefore, the air supplied inside the rooms 12A, 12B, 12C, 12D is naturally discharged from the exhaust ports. Then, the air discharged to the air conditioning room 30 via the exhaust pipes 22 is sterilized without being leaked outside from the air conditioning room, and supplied from the air supply port side openings.

The air conditioning room 30 has a sealed structure excluding the ventilation means, and is provided with an opening/closing door. The opening/closing door is used at the maintenance of the air conditioning room, and when the door is opened, the ultraviolet irradiation of the sterilization means, the ventilation sterilization means, and the ultraviolet irradiation means stops. Accordingly, a worker is not exposed to the ultraviolet rays at the maintenance of the air conditioning room.

Each of the rooms 12A, 12B, 12C, 12D includes a temperature and humidity sensor 70 that detects a temperature and a humidity inside the room, and a gas sensor 72 that detects concentrations of carbon dioxide and carbon monoxide. The temperature and humidity sensor 70 is electrically connected to the air conditioner 36 and the humidifier 38, and when a detected value of the temperature and humidity sensor 70 is transmitted to the air conditioner 36 and the humidifier 38, a control is performed to make the detected value become a set value.

The control unit 80 is disposed inside the building, and electrically connected to the gas sensor 72 and the ventilation means 40. Standard values of carbon dioxide and carbon monoxide (set values, for example, carbon dioxide concentration 1000 ppm or less, carbon monoxide concentration 10 ppm or less) are preliminarily determined, and when the detected value of the gas sensor 72 exceeds the standard value, the control unit 80 transmits a control signal to promote the ventilation to the ventilation means 40. The ventilation means 40 opens the opening/closing damper 42 to take external air into the air conditioning room, thereby allowing reduction of the concentrations of carbon dioxide and carbon monoxide to suppress them to the standard values or less.

### Operations

The following describes operations of the air conditioning and sterilization system 10 of the present invention configured above-described. An air adjusted to the set temperature and the set humidity is supplied from the air conditioning room 30 to each of the rooms 12A, 12B, 12C, 12D. The inside of the room is adjusted to the positive pressure, and the air that has circulated inside the room is discharged from the exhaust port. At this time, airborne bacteria in the room, infectious viruses brought from outside, and the like are discharged together. The air conditioning room 30 is under the negative pressure, and when the air discharged from the room is introduced in the room, the sterilization means 50 can sterilize the air with the ultraviolet ray having the wavelength of 254 nm. The sterilized air is supplied from the air supply port side openings 32 to the respective rooms 12A, 12B, 12C, 12D.

In each of the rooms 12A, 12B, 12C, 12D, the temperature and humidity sensor 70 and the gas sensor 72 are installed. The detected value of the temperature and humidity sensor 70 is transmitted to the air conditioner 36 and the humidifier 38, and the air conditioner 36 and the humidifier 38 perform the control of adjusting to the set temperature and the set humidity. The detected value of the gas sensor 72 is transmitted to the control unit 80. In the control unit 80, the standard values of carbon dioxide and carbon monoxide are preliminarily determined, and when the detected value of the gas sensor 72 exceeds the standard value, the control unit 80 transmits the control signal to promote the ventilation to the ventilation means 40. The ventilation means 40 opens the opening/closing damper 42 to take external air into the air conditioning room, thereby reducing the concentrations of carbon dioxide and carbon monoxide.

According to the present invention, since the air conditioning room can collectively manage the ventilation and the air sterilization process, the need for installing an air conditioner and a device for sterilization in each room is eliminated. The configuration in which the collective management is performed in the air conditioning room facilitates maintenance, and allows significant reduction in power consumption and initial equipment installation cost.

The preferable embodiment of the present invention is described above. However, the present invention is not limited to the above-described embodiment, and various changes can be made without departing from the gist of the present invention.

The present invention is not limited to the combination described in the embodiment, and can be performed by various combinations.

### DESCRIPTION OF REFERENCE SIGNS

10 Air conditioning and sterilization system
12A, 12B, 12C, 12D Room
14A, 14B, 14C, 14D Air supply port
16A, 16B, 16C, 16D Exhaust port
20A, 20B, 20C, 20D Air supply pipe
22A, 22B, 22C, 22D Exhaust pipe
30 Air conditioning room
32 Air supply port side opening
34 Exhaust port side opening
36 Air conditioner
38 Humidifier
40 Ventilation means
42 Opening/closing damper
44 Ventilation sterilization means
50 Sterilization means
52 Ultraviolet irradiation means
60 Blower
70 Temperature and humidity sensor
72 Gas sensor
80 Control unit

What is claimed is:

1. An air conditioning and sterilization system in which an air supply port and an exhaust port are provided to each of rooms of a building, an air supply pipe and an exhaust pipe are connected to the air supply port and the exhaust port, an air conditioning room is disposed between the air supply pipe and the exhaust pipe to adjust a temperature and a humidity of an air, and the air is circulated in each of the rooms, wherein,
the air conditioning room includes:
ventilation means that introduces an external air into the air conditioning room;
sterilization means that irradiates an air inside the air conditioning room with an ultraviolet ray having a wavelength of 254 nm as a dominant wavelength to sterilize the air; and
a blower that supplies the sterilized air to each of the rooms and discharges the air from the exhaust port by making each of the rooms have a positive pressure and the air conditioning room have a negative pressure.

2. The air conditioning and sterilization system according to claim 1, comprising:
a gas sensor that detects a gas concentration inside the room disposed in each of the rooms; and
a control unit electrically connected to the gas sensor and the ventilation means, the control unit performing a control of introducing an external air from the ventilation means when a detected value of the gas sensor exceeds a set value.

3. The air conditioning and sterilization system according to claim 2, wherein
the ventilation means includes ventilation sterilization means that irradiates an external air introduced by opening an opening/closing damper with an ultraviolet ray to sterilize the air.

4. The air conditioning and sterilization system according to claim 1, wherein
the air conditioning room includes ultraviolet irradiation means that irradiates a floor surface with ultraviolet rays having wavelengths of 254 nm and 185 nm as dominant wavelengths to generate an oxygen radical.

5. The air conditioning and sterilization system according to claim 1, wherein
the sterilization means is disposed at an air supply port side opening and an exhaust port side opening in the air conditioning room.
